(19) United States
(12) Patent Application Publication
(10) Pub. No.: US 2015/0266041 A1
(43) Pub. Date: Sep. 24, 2015

(54) SPRAY GUN

(71) Applicants: Ying-Chieh Liao, Taichung City (TW); Yu-Kuo Liao, Taichung City (TW)

(72) Inventors: Ying-Chieh Liao, Taichung City (TW); Yu-Kuo Liao, Taichung City (TW)

(21) Appl. No.: 14/223,978

(22) Filed: Mar. 24, 2014

(51) Int. Cl. B05B 7/24

(52) U.S. Cl. CPC B05B 7/2429; B05B 7/2416; B05B 7/2408

(57) ABSTRACT

A spray gun includes a control portion, a flared tube, a spray tube, and a connecting tube between the control portion and the spray tube. A fluid container communicates with the connecting tube via a sucking tube. An inner tube located in the spray tube has an end communicating with the sucking tube. The flared tube covers the spray tube and has a restriction portion therein to sleeve onto the spray tube. When the control portion is triggered to allow gas enter the connecting tube and the spray tube, fluid is sucked into the inner tube from the fluid container and is mixed with the gas to form mist. An air channel between the control portion and the fluid container is adapted for pressurize the fluid to facilitate sucking the fluid.

### BACKGROUND OF THE INVENTION

1. Field of the Invention

The present invention relates to a spray gun.

2. Description of the Prior Art

A conventional spray gun for cleaning, as disclosed in patent TW M444219, includes a spray tube, a fluid container, a sucking tube, and a flared tube. Pressurized-gas is directed into the spray tube, and the fluid in the fluid container is sucked out and mixed with the gas to form mist due to the Venturi effect. Thereby, the spray tube is swung in the flared tube to spray the mist on the surface to be cleaned.

However, the fluid may be difficult to be sucked out when the density of the fluid is too high or the pressure of gas is lowered. As a result, continuous mist is hard to generate.

### SUMMARY OF THE INVENTION

The main object of the present invention is to provide a wrench which is easy to operate and has a simple structure.

To achieve the above and other objects, a wrench of the present invention includes a main body, a jaw portion, a handle, and an elastic element.

The main body is formed in one piece and forms a fixed jaw at an end. The main body further forms a sliding slot along a first direction which is substantially perpendicular to an extending direction of the fixed jaw.

The jaw portion integrally forms a movable jaw at an end and a sliding portion at a bottom of the movable jaw. The sliding portion forms at least a restricting recess and is slidably disposed in the sliding slot. A jaw opening is defined between the movable jaw and the fixed jaw. An interface is defined by a contact surface between a bottom of the sliding portion and a bottom surface of the sliding slot away from the fixed jaw. An extension of the interface traverses the restricting recess.

The handle is rotatably disposed on the main body. The handle has at least one toggle element at an end, and the toggle element extends into the restricting recess. The handle is able to pivot between a driving position and a release position. When the handle is at the driving position, the toggle element abuts against the sliding portion to retain the jaw opening in a minimum size. When the handle is at the release position, the movable jaw is able to move away from the fixed jaw to enlarge the jaw opening.

The elastic element is disposed between the main body and the jaw portion and provides an elastic force so that the movable jaw tends to move toward the fixed jaw.

Thereby, the wrench of the present invention is able to fully transmit the force exerted by a user to the movable jaw and the fixed jaw. Thus, the wrench of the present invention is easy to be operated and has a simple structure to reduce manufacturing cost.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a lateral view of the present invention;

FIG. 3 is a profile of the present invention.

### DETAILED DESCRIPTION OF THE PREFERRED EMBODIMENTS

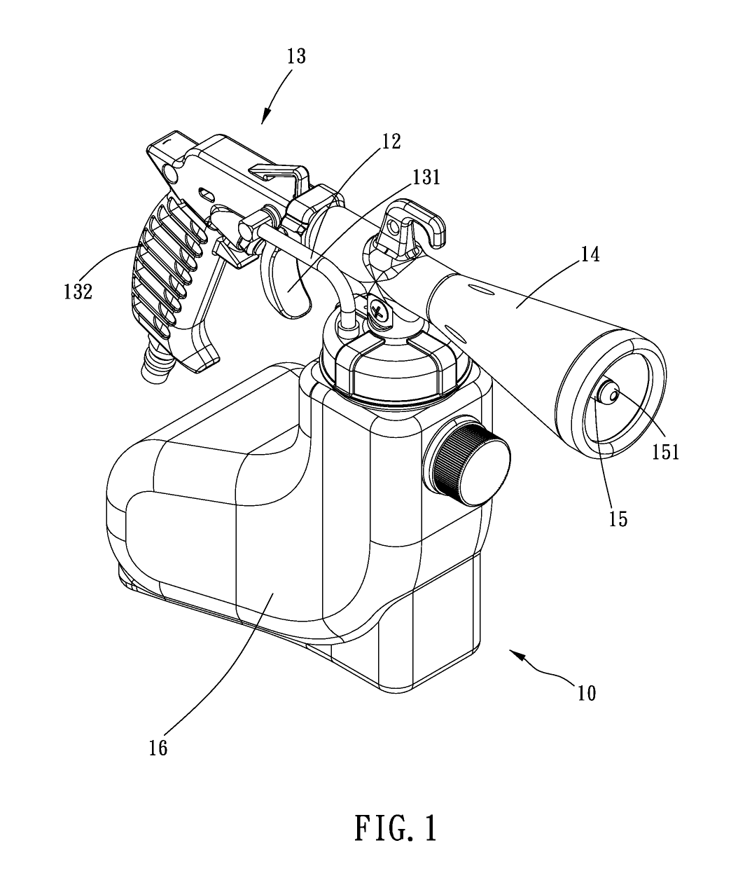

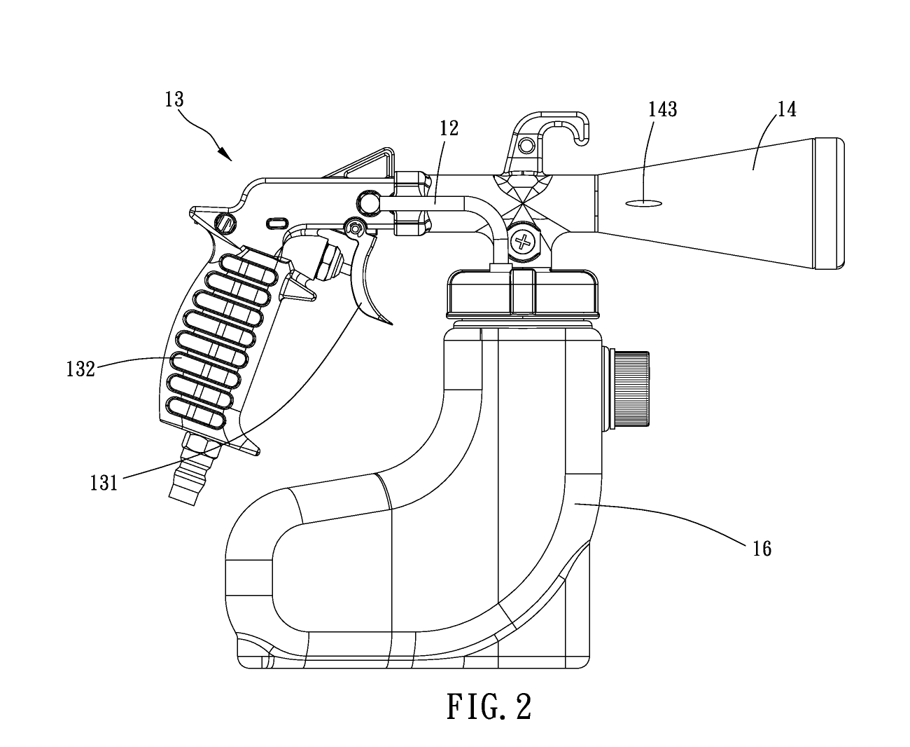

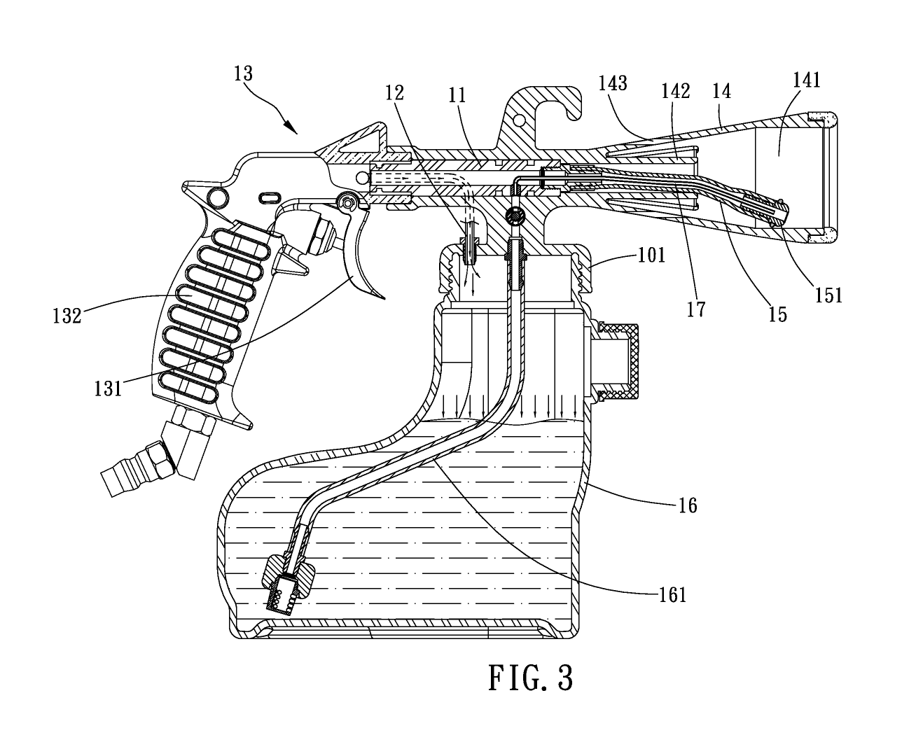

Please refer to FIG. 1 to FIG. 3, the spray gun 10 of the present invention includes a connecting tube 11, an air channel 12, a control portion 13, a flared tube 14, a resilient spray tube 15, a fluid container 16, and an inner tube 17.

The control portion 13 is connected with an end of the connecting tube 11 and a pressurized-air source therebetween so as to conditionally allow gas from the pressurized-air source enter the connecting tube 11. The control portion 13 is also connected with an end of the air channel 12 and the pressurized-air source therebetween so as to conditionally allow gas from the pressurized-air source enter the air channel 12. Practically, the pressurized-air source can be an air compressor. The control portion 13 partitions gas from the pressurized-air source into two portions to reroute it to the connecting tube 11 and the air channel 12. Preferably, the control portion 13 includes a handle 132 and a trigger 131. When the trigger 131 is triggered, gas from the pressurized-air source is allowed to enter the connecting tube 11 and the air channel 12.

The flared tube 14 is located at an end of the spray gun 10 opposite to the control portion 13. The flared tube 14 has a first end and an opposite second end. An inner diameter of the flared tube 14 is increasing from the first end toward the second end to form a working portion 141 at the second end. The flared tube 14 is further formed with a hollow restriction portion 142 therein. The restriction portion 142 has a predetermined length and is coaxial with the flared tube 14. Preferably, the restriction portion 142 is integrally formed in the flared tube 14 to be tunnel-shaped. Besides, in the present embodiment, a wall of the flared tube 14 is formed with at least one ventilation opening 143 to allow air outside enter the working portion 141 for facilitating mixing of the fluid and air in order to form finer mist.

The resilient spray tube 15 is located in the restriction portion 142. An end of the spray tube 15 closer to the first end of the flared tube 14 communicates with an end of the connecting tube 11 opposite to the control portion 13. An end of the spray tube 15 closer to the second end of the flared tube 14 is located in the working portion 141 but exposed out of the restriction portion 142. In the present embodiment, the spray tube 15 has a weight piece 151 at the end thereof located in the working portion 141 to help the spray tube 15 swing. An o-ring is disposed on a periphery of the weight piece 151 to prevent the weight piece 151 from hitting inner wall of the flared tube 14 when the spray tube swings.

The fluid container 16 does not communicate with outside directly. Instead, the fluid container 16 communicates with the connecting tube 11 via a sucking tube 161. An end of the air channel 12 opposite to the control portion 13 communicates with the fluid container 16. In the present embodiment, the spray gun 10 is fixedly formed with cover 101, and the fluid container 16 is detachably connected with the cover 101 by screwing or other means. The end of the air channel 12 opposite to the control portion 13 is detachably disposed on a top of the fluid container 16. More specifically, the end of the air channel 12 opposite to the control portion 13 is detachably disposed on the cover 101 to communicate with the fluid container 163. Optionally, the sucking tube 161 has a weight element at an end thereof inside the fluid container 16 to allow the fluid be sucked out when the fluid container 16 inclines.

The inner tube 17 is received in the spray tube 15 and the connecting tube 11. An end of the inner tube 17 communicates with an end of the sucking tube 161 located in the connecting tube 11. In the present embodiment, the inner tube 17 is not exposed out of the spray tube 15. A gap is formed between the inner tube 17 and the spray tube 15.

In use, one can pull the trigger 131 to allow gas enter the connecting tube 11 and the air channel 12. Due to the Venturi effect, gas passing through the spray tube 15 sucks the fluid in the fluid container 16 out and mixes with it to form mist. Thereby, the terminal end of the spray tube 15 swings to spread the mist. In addition, the spray tube 15 is restricted by the restriction portion 142 so that the swinging range of the spray tube 15 is limited. Besides, the pressurized gas also enters the fluid container 16 via the air channel 12, so fluid in the fluid container 16 is squeezed out by the pressurized gas to help the fluid mix with the gas.

What is claimed is:

1. A spray gun, including:
a connecting tube;
an air channel;
a control portion, the control portion being connected with an end of the connecting tube and a pressurized-air source therebetween so as to alternatively allow air from the pressure-air source enter the connecting tube, the control portion being connected with an end of the air channel and the pressure-air source therebetween so as to alternatively allow air from the pressure-air source enter the air channel;
a flared tube, located at an end of the spray gun opposite to the control portion, the flared tube having a first end and an opposite second end, an inner diameter of the flared tube increasing from the first end toward the second end, the flared tube having a working portion at the second end, the flared tube being formed with a restriction portion therein, the restriction portion having a predetermined length and being hollow, the restriction portion being coaxial with the flared tube;
a resilient spray tube, disposed in the restriction portion, an end of the spray tube closer to the first end of the flared tube communicating with an end of the connecting tube opposite to the control portion, an end of the spray tube closer to the second end of the flared tube being located at the working portion and being exposed out of the restriction portion;
a fluid container, the fluid container being connected with the connecting tube via a sucking tube, an end of the air channel opposite to the control portion communicating with the fluid container;
an inner tube, located in the spray tube and the connecting tube, an end of the inner tube communicating with an end of the sucking tube located in the connecting tube;
wherein when gas passes through the spray tube to swing the spray tube, range of swinging of the spray tube is restricted due to the restriction portion.

2. The spray gun of claim 1, wherein gas from the pressurized-gas source is partitioned into two portions and rerouted to the connecting tube and the air channel by the control portion.

3. The spray gun of claim 1, wherein the fluid container is detachably disposed on the spray gun.

4. The spray gun of claim 1, wherein a wall of the flared tube is formed with at least one ventilation opening for allowing gas outside enter the flared tube.

5. The spray tube of claim 1, wherein the control portion includes a handle and a trigger, gas from the pressurized-air source is allowed to enter the connecting tube and the air channel when the trigger is pulled.

6. The spray tube of claim 1, wherein air channel is detachably connected to a top of the fluid container.
